(19) United States
(12) Patent Application Publication
(10) Pub. No.: US 2006/0253229 A1
(43) Pub. Date: Nov. 9, 2006

(54) Attachment structure for remote controller

(75) Inventor: Hiroshi Kohata, Shinagawa-ku (JP)

Correspondence Address: DARBY & DARBY P.C., P. O. BOX 5257, NEW YORK, NY, 10150-5257, US

(73) Assignee: SMK CORPORATION, Tokyo (JP)

(21) Appl. No.: 11/253,003

(22) Filed: Oct. 17, 2005

(30) Foreign Application Priority Data
May 9, 2005 (JP) 2005-136287

(51) Int. Cl. G05D 1/00

(52) U.S. Cl. 701/2

(57) ABSTRACT

The present invention is a structure for attaching a remote control to a steering wheel using a holder, to allow the positions of operation buttons and text display positions of an operation surface to be set up freely, taking into account visibility and operability for the user. The remote control and the holder are formed so that they can engage with each other. An angle adjustment engagement section is formed on the engagement sections thereof. The angle adjustment engagement section is formed from an external gear engagement section formed on the remote control and an internal gear engagement section formed on the holder. The engagement positions of the external gear and internal gear are used to perform angle adjustments around central axes, which form a shared axis. The operation surface of the remote control is formed roughly perpendicular to the center axis.

### INCORPORATION BY REFERENCE

The present application claims priority under 35 U.S.C. §119 to Japanese Patent Application No. 2005-136287 filed on May 9, 2005. The content of the application is incorporated herein by reference in its entirety.

### BACKGROUND OF THE INVENTION

The present invention relates to an attachment structure for attaching a remote controller (hereinafter referred to as a remote control) to a support member (e.g., the steering wheel of an automobile).

FIG. 9 shows a known example of a structure for attaching a remote control to a steering wheel in which a remote control 101 is attached to the wheel 1 using a securing band 103. Wheel 1 is equipped with a central section 11, rod-shaped spokes 12 projected radially from the central section 11, and a circular grip 13 connected to the ends of the spokes 12.

Also shown is an instrument panel 105, a navigation device 107, a monitor 109 of the navigation device 107, and a switch 111. When the switch 111 is pressed and a signal such as an infrared beam is emitted from a light-emitting section of the remote control 101, the signal is received by a light-receiving section of the monitor 109 and is sent to a control module of the navigation device 107.

With the conventional example shown in FIG. 9, the securing band 103 can be used to change the position at which the remote control 101 is attached to the steering wheel 1. However, since the attachment position of the remote control 101 must not obstruct driving operations and field of view, it is not possible to attach the remote control 101 so that it is oriented properly relative to the light-receiving section of the monitor 109.

In order to overcome the problem described above, there has been proposed a structure equipped with a holder attached to a steering wheel and a remote control attached to the holder in a manner that allows adjustment of the angle (e.g., see Japanese Laid-Open Patent Publication Number 2001-309466).

However, with this technology, in order to orient the signal in an appropriate direction, the remote control is attached to the holder so that it is possible to adjust the angle around an axis parallel to the operation surface of the remote control (the surface with the operation buttons). Thus, it is not possible to freely design the position of the operation buttons or the text display position of the operation surface to take into account visibility and operability for the user.

### OBJECTS AND SUMMARY OF THE INVENTION

The object of the present invention is to overcome the problems described above and to provide a remote control attachment structure that makes it possible to freely design the position of the operation buttons and the text display position of the operation surface, taking into account visibility and operability for the user.

The invention provides a remote controller attachment structure for attaching a remote controller to a member using a holder wherein an engagement section engages with the remote controller and the holder. An angle adjustment engagement section is formed on the engagement section of the remote controller and holder allows positioning by aligning center axes so that angle-adjustable engagement is possible. Also, an operation surface of the remote controller is formed roughly perpendicular to the center axis.

Another embodiment is that the angle adjustment engagement section is a gear-shaped engagement section with the engagement section of the remote controller and the holder being formed in a gear shape.

A further embodiment includes the engagement section of the remote controller and the holder equipped with a cylindrical outer surface and inner surface that face each other and have aligned central axes. The gear-shaped engagement section includes an internal gear engagement section and an external gear engagement section. The internal gear engagement section is equipped with a plurality of internal gear teeth formed at a fixed pitch along a perimeter direction of an inner cylindrical surface of the holder. The external gear engagement section is equipped with a plurality of external gear teeth formed along a perimeter direction of an outer cylindrical surface of the remote controller and capable of being meshed with the inner gear teeth during engagement with the holder.

The engagement section of the remote controller and the holder can also be equipped with a cylindrical outer surface and inner surface that face each other and have aligned central axes. The gear-shaped engagement section includes an internal gear engagement section and an external gear engagement section. The internal gear engagement section is equipped with a plurality of internal gear teeth formed at a fixed pitch along a perimeter direction of an inner cylindrical surface of the remote controller. The external gear engagement section is equipped with a plurality of external gear teeth formed along a perimeter direction of an outer cylindrical surface of the holder. The external gear teeth can be meshed with the inner gear teeth during engagement with the remote controller.

Another embodiment of the invention provides a remote controller attachment structure where the angle adjustment engagement section is an interlocking engagement section formed with a projection and cavity at the engagement section of the remote controller and the holder.

An embodiment of a remote controller attachment structure where the engagement section of the remote controller and the holder is equipped with a flat upper surface and lower surface facing each other and formed roughly perpendicular to the central axes. The interlocking engagement section can be formed from a concave engagement section and a convex engagement section. The concave engagement section is equipped with a plurality of cavities formed at a fixed pitch along a perimeter direction centered on an intersection point between the center axis and the upper flat surface of the holder. The convex engagement section is equipped with projections formed on the lower flat surface of the remote controller and engageable with the cavities during engagement with the holder.

The invention provides a remote controller attachment structure where the engagement section of the remote controller and the holder can be equipped with a flat upper surface and lower surface facing each other and formed roughly perpendicular to the central axes. The interlocking engagement section can be formed from a concave engagement section and a convex engagement section. The concave engagement section is equipped with a plurality of cavities formed at a fixed pitch along a perimeter direction centered on an intersection point between the center axis and the lower flat surface of the remote controller. The convex engagement section is equipped with projections formed on the upper flat surface of the holder and engageable with the cavities during engagement with the remote controller.

The invention provided above is a remote controller attachment structure where the member is a steering wheel of an automobile.

An engagement section can engage with the remote controller and the holder is formed, so the remote control and the holder are engaged and aligned in an angle-adjustable manner around a center axis roughly perpendicular to the operation surface of the remote control. The operation button positions and text display positions on the operation surface of the remote control can be positioned in an angle-adjustable manner around the center axis along the same plane as the operation surface. Thus, the operation buttons and text display positions can be set up freely to take into account visibility and operability for the operator.

The invention provides the angle adjustment engagement section in a gear-shaped engagement section with the engagement section of the remote controller and the holder being formed in a gear shape. The positioning angle can be easily adjusted and set up based on the number of gear teeth formed on the engagement section of the remote control and holder.

The embodiment above provides the gear-shaped engagement section with an internal gear engagement section and an external gear engagement section. The internal gear engagement section can be equipped with a plurality of internal gear teeth formed at a fixed pitch along a perimeter direction of an inner cylindrical surface of either the holder or remote control. The external gear engagement section is equipped with a plurality of external gear teeth formed along a perimeter direction of an outer cylindrical surface of the remote controller or holder, opposite of the internal gear teeth and capable of being meshed with the inner gear teeth during engagement with the holder. The number of internal gear teeth formed on the inner cylindrical surface of the holder can be used to easily define the number of angle adjustment positions. The positioning angle can be adjusted by turning the remote control around the center axis by a predetermined angle.

The invention provides the angle adjustment engagement section with an interlocking engagement section formed with a projection and cavity at the engagement section of the remote controller and the holder. The number of interlocking sections in the engagement section of the remote control and the holder can be used to easily define the adjustment angle for positioning.

Another embodiment can form the interlocking engagement section from a concave engagement section and a convex engagement section. The concave engagement section can be equipped with a plurality of cavities formed at a fixed pitch along a perimeter direction centered on an intersection point between the center axis and the upper flat surface of the holder or the lower flat surface of the remote controller. The convex engagement section can be equipped with projections formed on the lower flat surface of the remote controller or on the upper flat surface of the holder. The projections are engageable with the cavities during engagement with either the holder or the remote controller. The adjustment angle for positioning can be easily defined based on the number of cavities formed on the upper flat surface of either the holder or the lower flat surface of the remote controller.

An embodiment is that the member is a steering wheel of an automobile and the present invention can be used as a structure for attaching an automotive remote control. The positions for operations buttons and text display positions of the remote control can be set up freely, taking into account the visibility and operability for the automobile driver. Thus, the invention makes it easy to operate the switches in a tactile manner without visual feedback.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is an exploded perspective drawing showing an embodiment of the present invention with a section omitted;

FIG. 2 is a plan drawing showing the attached state of an embodiment;

FIG. 3 is a cross-section detail drawing along the 3-3 line in FIG. 2;

FIG. 4 is a cross-section detail drawing along the 4-4 line in FIG. 2;

FIG. 5 is a plan drawing showing the attached state of the above embodiment when the attachment position has been changed;

FIG. 6 is a plan drawing showing the attached state of another embodiment of the present invention;

FIG. 7 is a cross-section detail drawing along the 7-7 line in FIG. 6;

FIG. 8 is a plan drawing of FIG. 6 with the remote control removed; and

FIG. 9 is a drawing of the prior art.

### DETAILED DESCRIPTION OF THE EMBODIMENTS

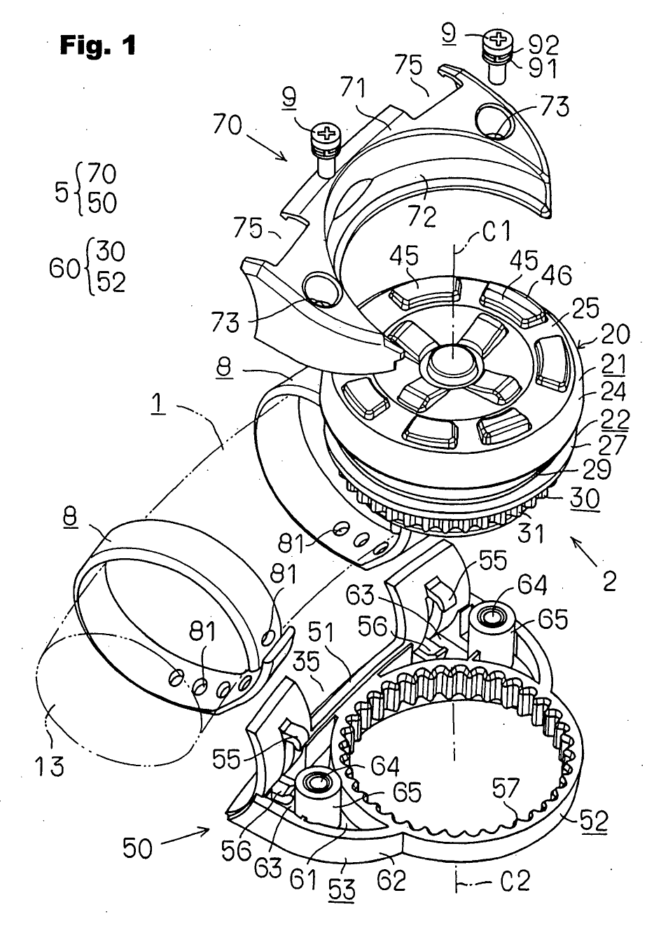

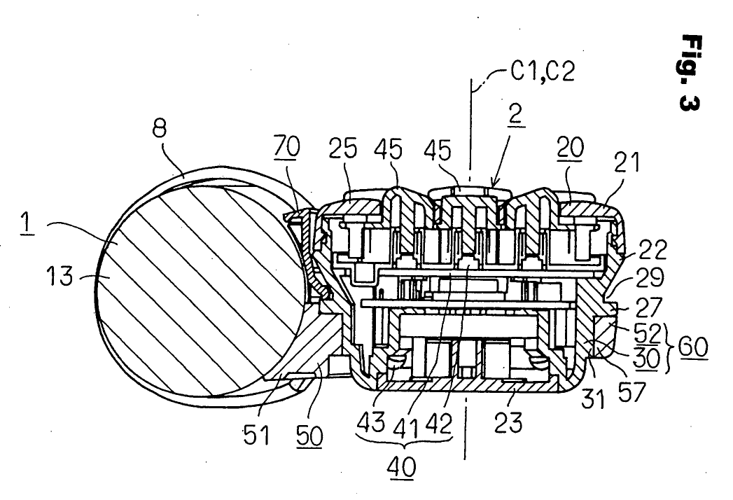

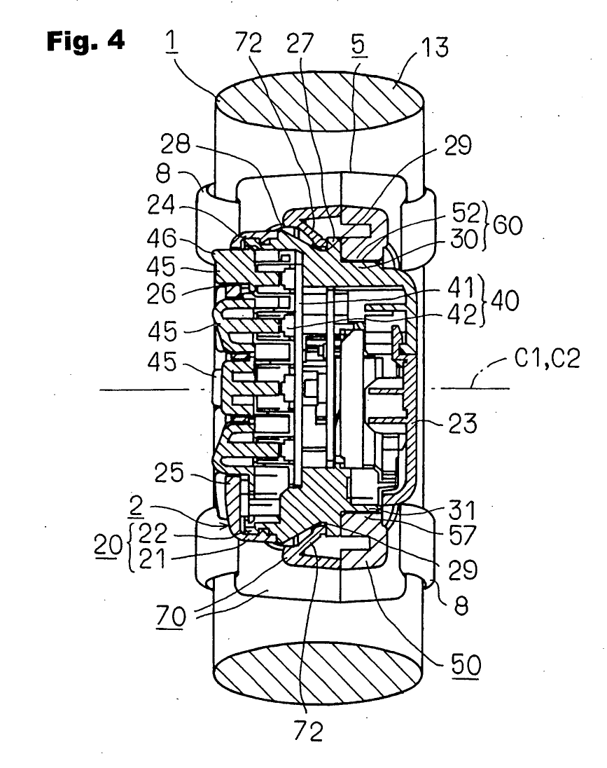

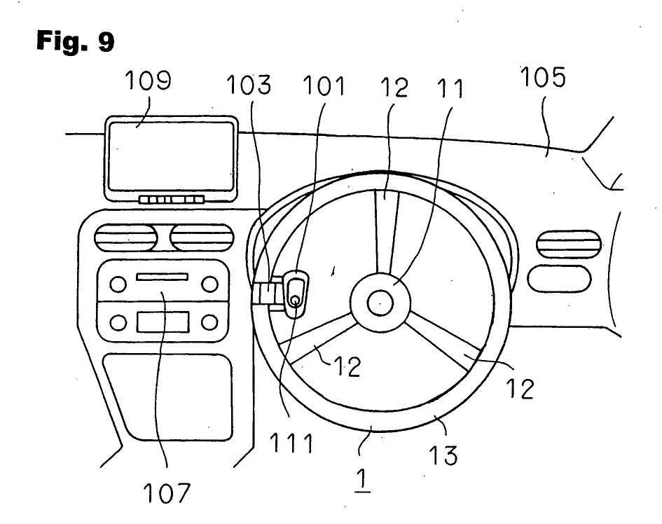

An embodiment of the present invention is shown in FIG. 1 through FIG. 4. The figures show an automobile steering wheel 1, a remote control 2, a holder 5, a securing band 8, and setscrews 9. The steering wheel 1 is formed identical to the steering wheel 1 shown in FIG. 9 and is equipped with central section 11, spokes 12, and grip 13.

The remote control 2 is equipped with a case 20 formed from a synthetic resin, and a circuit unit 40 housed and supported in the case 20.

The case 20 is formed from an upper case 21, a lower case 22, and a bottom cover 23, which can be engaged integrally.

The case 21 is equipped with a roughly cylindrical body 24 and a disk-shaped upper plate 25 that seals the upper surface of the body 24. On the upper plate 25, there are formed through-holes 26 at the center, the inner perimeter, and the outer perimeter to allow the heads of operation buttons 45, described later, to be passed through and projected. Thus, the upper surface of the upper plate 25 corresponds to the operation surface of the remote control 2.

The lower case 22 is formed with a roughly cylindrical outer shape with a collar 27 projecting outward from the central section thereof. A body 28 engages with the body 24 of the upper case 21 above the collar 27. The body 28 can be formed with an outer diameter that tapers downward. An engagement groove 29 is formed along the outer perimeter continuous with the collar 27.

An external gear engagement section 30 is formed on the lower case 22 below the collar 27. The outer shape of the external gear engagement section 30 is formed as a cylinder with multiple external gear 31 being formed on the outer perimeter of the cylindrical surface at a fixed pitch along a perimeter direction. A central axis C1 of the external gear engagement section 30 passes roughly through the center of the upper plate 25 and is roughly perpendicular to the plane of the upper plate 25.

A circuit unit 40 is equipped with a substrate 41 formed with a predetermined circuit pattern, switches 42 mounted on the substrate 41, and circuit elements such as LED 43. Operation buttons 45 of the switches 42 are projected outward from the operation surface so that the heads thereof can pass through the through-holes 26-26 of the upper plate 25.

The heads of the operation buttons 45 can be marked with the numbers “1”-“12” corresponding to the functions assigned to the operation buttons.

In order to facilitate tactile operations, projections 46 are formed on the heads of the operation buttons 45 corresponding to the respective identifications “1”, “4”, “7”.

The holder 5 is formed from a main holder unit 50 shaped from synthetic resin and a holder cover 70. The main holder unit 50 is equipped with an abutment piece 51 that abuts against the steering wheel 1, an internal gear engagement section 52 that can engage with the external gear engagement section 30 of the remote control 2, and a connecting section 53 connecting the abutment piece 51 and the internal gear engagement section 52.

The external gear engagement section 30 and the internal gear engagement section 52 form a gear engagement section 60 that serves as an angle adjustment engagement section.

The curvature of the inner surface of the abutment piece 51 that abuts the grip 13 is formed to be roughly the same as the curvature of the grip 13 so that there can be a tight fit with a section of the grip 13 of the steering wheel 1. A cut-out 35 is formed at the center of the upper portion of the abutment piece 51.

A pair of engagement claws 55, 56 are projected outward from either side of the abutment piece 51 above and below the perpendicular axis (the up/down axis in FIG. 1).

The internal gear engagement section 52 is formed in a ring shape (a short cylindrical shape) with multiple inner gear teeth 57 formed along the perimeter direction of the inner cylindrical surface thereof.

A center axis C2 of the inner gear engagement section 52 is aligned with a center axis C1 of the external gear engagement section 30 during engagement with the external gear engagement section 30.

The connecting section 53 is equipped with a horizontal connecting section 61 and a vertical connecting section 62. Insertion holes 63 are formed around the horizontal connecting section 61 to allow insertion of a securing handle 8, and bosses 65 formed with threaded holes 64 for the setscrews 9 are projected. The insertion holes 63 also serve as escape holes for the lower engagement claws 56.

The holder cover 70 is equipped with a main cover unit 71 covering the section of the main holder unit 50 above the connecting section 53. An engagement projection 72 is projected from the lower section of the main cover unit 71.

The main cover unit 71 is formed with attachment holes 73 for insertion of the threaded sections of the setscrews and for preventing the head from slipping out. The main cover unit 71 is also formed with cut-outs 75 for insertion of securing handles 8.

The engagement projection 72 is formed roughly as a semicircular ring to allow engagement with roughly half the perimeter of the engagement groove 29 of the lower case 22. The radial section of the engagement projection 72 is downwardly tapered from the outer perimeter to the inner perimeter.

The securing handle 8 is used to attach the holder 5 to the steering wheel 1 and is formed as a band from a material, e.g., synthetic rubber or any other suitable material, having ample stretchability. Elliptical engagement holes 81 are formed along the longitudinal axis thereof.

Next, the attachment of the remote control 2 to the steering wheel 1 using the holder 5 and the securing handle 8 will be described.

Using the securing handle 8, the main holder unit 50 is secured to a preferred position of the grip 13 of the steering wheel 1.

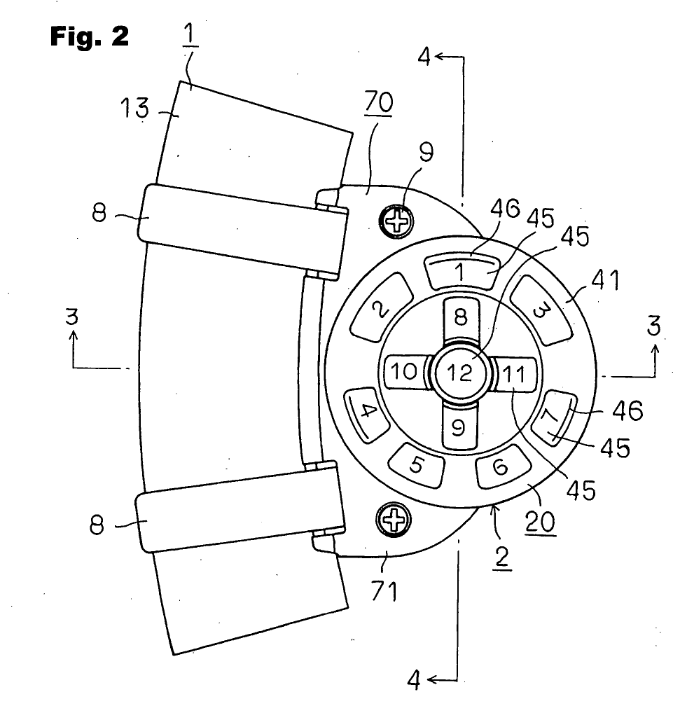

For example, as shown in FIG. 2, if the main holder unit 50 is to be attached to a central section of the left side of the grip 13 of the steering wheel 1, the abutment piece 51 of the main holder unit 50 is pressed against the corresponding section of the grip 13, the engagement holes 81 on one side of the securing handles 8 are engaged with the engagement claws 55, the securing handles 8 are wrapped around the corresponding section of the grip 13, the corresponding engagement holes 81 on the other side are engaged with the engagement holes 56 while stretching the securing handle 8, thus firmly attaching the main holder unit 50 to the steering wheel 1.

Next, the remote control 2 is aligned so that the text display position, including the numbers “1”-“2”, etc. of the operation buttons 45 of the remote control 2 are at a preferred position for the driver. The external gear engagement section 30 of the remote control 2 is engaged with the internal gear engagement section 52 of the main holder unit 50. For this positioning, the angle around the central axis C1 can adjusted over multiple steps by changing the meshing positions of the external gear 31 of the external gear engagement section 30 and the internal gear 57 of the internal gear engagement section 52.

For example, to position the operation buttons 45, as shown in FIG. 2, the external gear engagement section 30 of the remote control 2 can be engaged with the internal gear engagement section 52 of the main holder unit 50 so that the operation button 45 that is printed with “1” is at the top.

Further, the main holder unit 50 is covered with the holder cover 70 and the stopping screws 9 are screwed into the threaded hole 64 of the main holder unit 50. Thus, this secures the remote control 2 to the holder 5. More specifically, the main cover unit 71 of the holder cover 70 covers the section above the connecting section 53 of the main holder unit 50. The engagement projection 72 of the holder cover 70 engages with the engagement groove 29 of the main holder unit 50, stopping screws 9 are screwed into threaded holes 64 of the main holder unit 50 through the attachment holes 73 and interposing washers 91 and spring washers 92, resulting in the remote control 2 being secured to the holder 5.

The embodiment described above presents an example in which the remote control 2 is attached to the center of the left side of the grip 13, but the present invention is not restricted to this. For example, attachment can be performed at the right side, top side, bottom side, or the like of the grip 13 of the steering wheel 1.

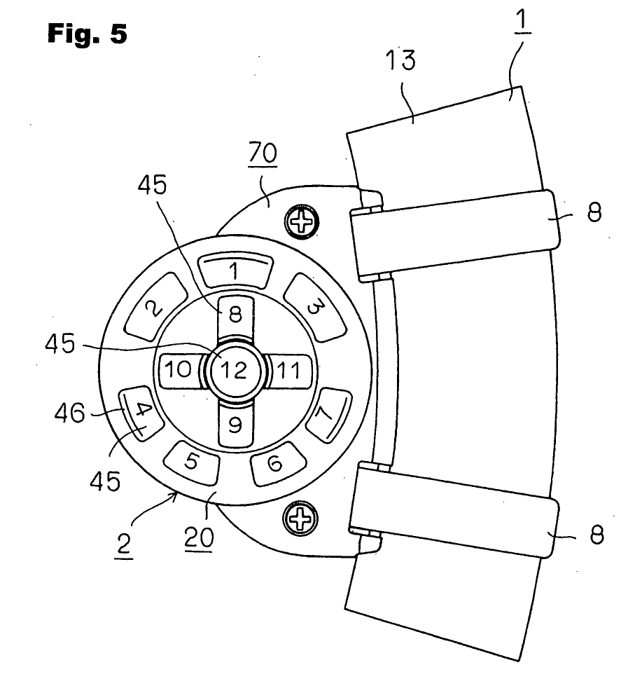

For example, as shown in FIG. 5, the remote control 2 can be attached to the center of the right side of the grip 13 of the steering wheel 1.

In the embodiment described above, the number of the external gear 31, 31 of the external gear engagement section 30 and the number of internal gear 57, 57 of the internal gear engagement section 52 are made identical in order to improve and stabilize the engagement between the remote control 2 and the holder 5. However, the present invention is not restricted to this. Similar angle adjustments can be made in cases where the teeth count on one side is less than the teeth count on the other side.

For example, external gear count of the external gear engagement section can be one half the internal gear count of the internal gear engagement section, with the external gear pitch being twice the internal gear pitch.

In the embodiment described above, the internal gear engagement section is formed on the holder and the external gear engagement section is formed on the remote control. However, the present invention is not restricted to this, and it is possible for the external gear engagement section to be formed on the holder and for the internal gear engagement section to be formed on the remote control.

For example, concave grooves extending along the center axis C2 can be formed at a fixed pitch along the perimeter of the inner cylindrical surface of the engagement section of the holder, and ridges can be formed that engage with the concave grooves of the holder in a manner that allows angle adjustment when engaged with the holder (a ridge extending along the center axis C1).

In the embodiment described above, the internal gear engagement section is formed on either the holder or the remote control and the external gear engagement section is formed on the remaining element. However, the present invention is not restricted to this, and it would be possible to form multiple cavities at a fixed pitch along the perimeter direction on the engagement surface (cylindrical surface) of either the holder or the remote control, with projections that can be engaged with these cavities formed on the remaining element.

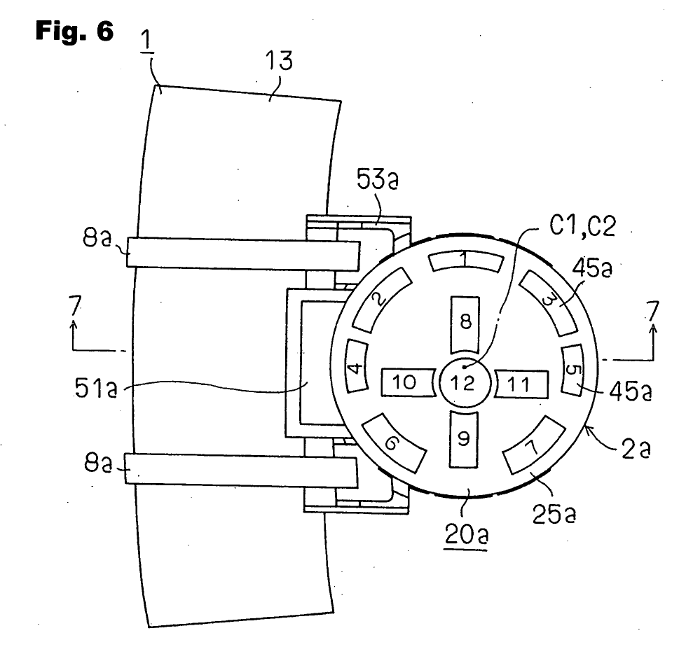

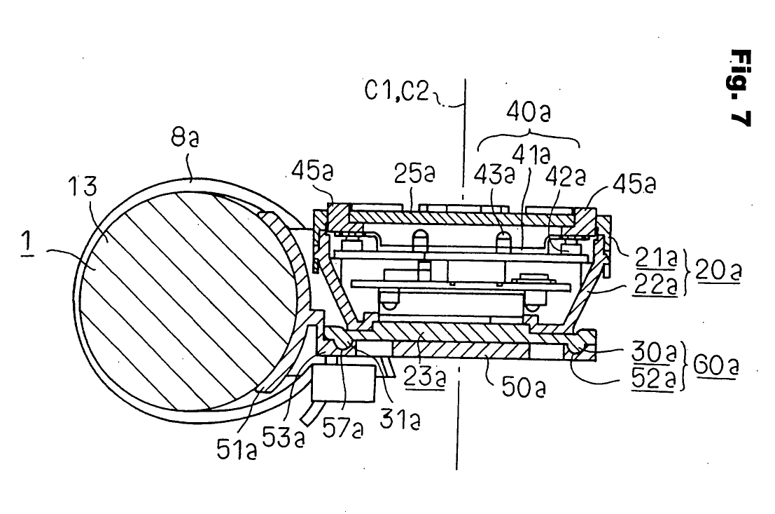

Another embodiment of the present invention is shown in FIG. 6 through FIG. 8. These figures show a steering wheel 1, a remote control 2a, a holder 5a, and a securing band 8a. Remote control 2a is equipped with a case 28 formed in a roughly cylindrical shape and a circuit unit 48 housed in a case 20a. Case 20a is formed from an upper case 21a and a lower case 22a and a bottom cover (e.g., a battery cover) 23a.

The upper surface of an upper plate 25a of the upper case 21a corresponds to the operation surface of the remote control 2a, and the heads of operation buttons 45a can pass through the upper plate 25a and are projected outward.

The upper section of the lower case 22a is engaged with the upper case 21a and the lower section is formed so that the outer diameter is tapered downward. The bottom cover 23a engages with the bottom surface of the lower case 22a and is formed roughly in a disc shape. An engagement projection 30a is formed on the bottom surface of the bottom cover 23a.

The engagement projection 30a is formed from roughly hemispherical projections 31a projected downward from the bottom surface of the bottom cover 23a. The projections 31a can be formed at a fixed pitch in the perimeter direction around the center axis C1, which passes through roughly the center of the bottom cover 23a and is roughly perpendicular to the plate surface of the bottom cover 23a.

The holder 5a is equipped with a main holder unit 50a formed roughly in a disc-shape, and an abutment piece 51a connected to the main holder unit 50a and that tightly fits against the grip 13, and a connecting section 53a that connects the two elements.

On the upper surface of the main holder unit 50a is formed a concave engagement section 52a that engages with the engagement projection 30a of the remote control 2a in a manner that allows angle adjustment.

The convex engagement projection 30a and the concave engagement section 52a form an interlocking engagement section 60a that serves as an angle adjustment engagement section.

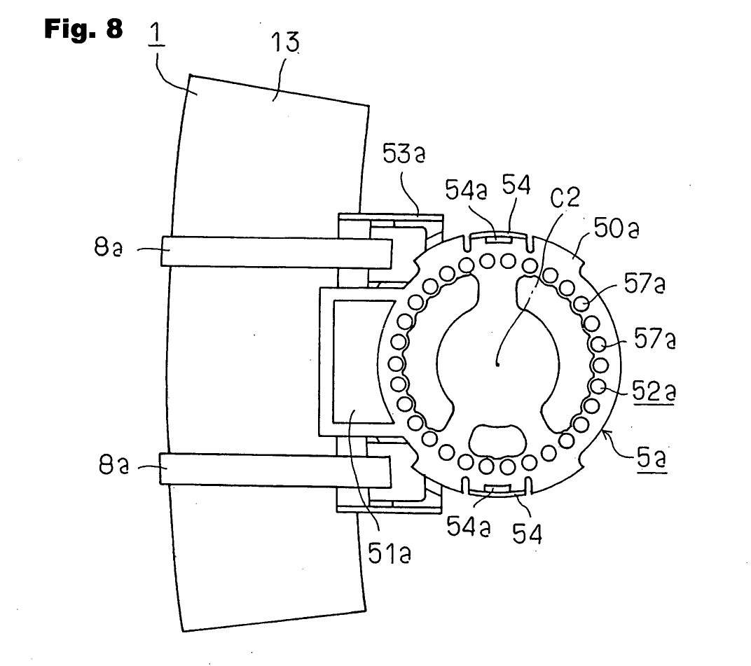

The concave engagement section 52a is formed from hemispherical cavities 57a on the upper surface of the main holder unit 50a. As shown in FIG. 8, the cavities 57a are formed at a fixed pitch along the perimeter direction and around a central axis C2, which passes through roughly the center of the main holder unit 50a and is roughly perpendicular to the plate surface of the main holder unit 50a.

The central axes C1, C2 are identical when the convex engagement section 30a of the remote control 2a and the concave engagement section 52a of the holder 5a are engaged and aligned and angle-adjusted.

Leaf spring engagement pieces 54 are projected upward from the ends of the upper surface of the main holder unit 50a (the upper and lower ends in FIG. 8). Engagement claws 54a are formed at the free ends of the engagement pieces 54 and engaged with engagement holes (not shown in the figures) formed on the side wall of the lower case 22a when the lower case 22a is engaged.

In the embodiment described above, the number of projections 31a of the convex engagement section 30a is identical with the number of cavities 57a of the concave engagement section 52a in order to improve and stabilize the engagement between the remote control 2a and the holder 5a. However, the present invention is not restricted to this, and similar angular adjustments can be made even if the number of one is less than the number of the other.

For example, the number of projections of the convex engagement section can be one-half the number of cavities of the concave engagement section, with the pitch between projections being twice the pitch between cavities.

In the embodiment described above, the convex engagement section 30a is formed on the bottom cover 23a of the case 20a, and the convex engagement section 52a is formed on the main holder unit 50a. However, the present invention is not restricted to this, and it is possible to form the concave engagement section on the bottom cover 23a of the case 20a, and the convex engagement section on the main holder unit 50a.

In the embodiment described above, the concave engagement section is formed on either the holder or the remote control, and the convex engagement section is formed on the remaining element. However, the present invention is not restricted to this, and it is possible to form multiple radial concave grooves at a fixed pitch around an intersection with the central axis on the engagement surface (abutment plane) of either the holder or the remote control, while forming on the remaining element ridges that can engage with these concave grooves. The multiple radial concave grooves and the ridges that engage therewith can also be used if engagement takes place with a gear shape along the perimeter direction.

In order to simplify the descriptions, in the previous embodiments, no text or numerals are printed on the operation surface of the remote controls 2, 2a and the heads of the operation buttons 45, 45a are printed with the numbers “1”-“12”. However, the present invention is not restricted to this, and it would be possible to print text, numerals, symbols, or the like on the operation surfaces of the remote controls 2, 2a and/or text, numerals, or symbols can be printed on the operation buttons 45, 45a.

For example, the numbers “1”-“5” on the heads of the operation buttons 45, 45a of the remote controls 2, 2a can be changed to “Destination”, “Talk” etc., the numbers “6”, “7” can be changed to the symbols “−” or “+”, and the number “12” can be changed to “Run.”

In the embodiments described above, the remote controls 2, 2a are attached to the grip 13 of the steering wheel 1. However, the present invention is not restricted to this, and it would be possible to attach the remote control to the spoke of the steering wheel 1.

In the embodiments, the engagement sections of the remote control and the holder are formed with cylindrical shapes. However, the present invention is not restricted to this, and it would also be possible for the engagement sections of the remote control and the holder to be formed as polygonal cylinders.

For example, it would also be possible to use the present invention when the engagement section of the remote control and the holder are formed as an cuter surface and an inner surface of facing polygonal cylinders with matching central axes. In this case, there is no need to form a gear shape on the engagement surfaces.

In the above embodiments, the attachment is performed on the steering wheel, but it would also be possible to perform attachment on an element other than the steering wheel.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A remote controller attachment structure for attaching a remote controller to a member using a holder comprising:
an engagement section engaging said remote controller and said holder;
an angle adjustment engagement section is formed on said engagement section of said remote controller and said holder to allow positioning by aligning a center axis of said remote controller with a center axis of said holder permitting angle-adjustable engagement; and
an operation surface of said remote controller formed roughly perpendicular to said center axis of said remote controller.

2. A remote controller attachment structure according to claim 1, wherein said angle adjustment engagement section is a gear-shaped engagement section, wherein said engagement section of said remote controller and said holder being formed in a gear shape.

3. A remote controller attachment structure according to claim 2 wherein:
said engagement section of said remote controller and said holder includes an outer surface and an inner surface facing each other and aligning said center axis of said remote control and said center axis of said holder; and
said gear-shaped engagement section comprising;
an internal gear engagement section including a plurality of internal gear teeth formed at a fixed pitch along a perimeter direction of an inner cylindrical surface of said holder; and
an external gear engagement section, wherein including a plurality of external gear teeth formed along a perimeter direction of an outer cylindrical surface of said remote controller and being meshed with said inner gear teeth during engagement with said holder.

4. A remote controller attachment structure according to claim 2 wherein:
said engagement section of said remote controller and said holder is equipped with a cylindrical outer surface and inner surface that face each other and have aligned center axes; and
said gear-shaped engagement section includes an internal gear engagement section and an external gear engagement section, said internal gear engagement section being equipped with a plurality of internal gear teeth formed at a fixed pitch along a perimeter direction of an inner cylindrical surface of said remote controller, and said external gear engagement section being equipped with a plurality of external gear teeth formed along a perimeter direction of an outer cylindrical surface of said holder and capable of being meshed with said inner gear teeth during engagement with said remote controller.

5. A remote controller attachment structure according to claim 1, wherein said angle adjustment engagement section is an interlocking engagement section including a projection and cavity at said engagement section of said remote controller and said holder.

6. A remote controller attachment structure according to claim 5 wherein:
said engagement sections of said remote controller and said holder are equipped with an upper surface and a lower surface facing each other and formed roughly perpendicular to said center axes; and
said interlocking engagement section comprising;
a concave engagement section having a plurality of cavities formed at a fixed pitch along a perimeter direction centered on an intersection point between said center axis of said holder and said upper flat surface of said holder; and
a convex engagement section, having projections formed on said lower surface of said remote controller and engageable with said cavities during engagement with said holder.

7. A remote controller attachment structure according to claim 5 wherein:
said engagement sections of said remote controller and said holder are equipped with an upper surface and a lower surface facing each other and formed roughly perpendicular to said center axes; and
said interlocking engagement section comprising;
a concave engagement section having a plurality of cavities formed at a fixed pitch along a perimeter direction centered on an intersection point between said center axis of said remote controller and said lower flat surface of said remote controller; and
a convex engagement section, having projections formed on said upper surface of said holder and engageable with said cavities during engagement with said remote controller.

8. A remote controller attachment structure according to claim 1 wherein said member is a steering wheel of an automobile.
